(19) United States
(12) Patent Application Publication
(10) Pub. No.: US 2001/0040723 A1
(43) Pub. Date: Nov. 15, 2001

(54) Differential interference optical system

(76) Inventor: Kenichi Kusaka, Sagamihara-shi (JP)

Correspondence Address: PILLSBURY WINTHROP, LLP, 1100 NEW YORK AVENUE, NW, 9TH FLOOR, WASHINGTON, DC, 20005, US

(21) Appl. No.: 09/745,430

(22) Filed: Dec. 26, 2000

(30) Foreign Application Priority Data
Dec. 24, 1999 (JP) HEI 11-367868
Dec. 1, 2000 (JP) 2000-371496

(51) Int. Cl. G02B 21/00

(52) U.S. Cl. 359/370

(57) ABSTRACT

A differential interference optical system includes an illumination source, a first polarizing element for converting a ray of light emitted from the illumination source into linearly polarized light, a first polarizing member for separating the linearly polarized light converted by the first polarizing element into two linearly polarized components which vibrate perpendicular to each other and travel at a slight separation angle, a lens system for illuminating and observing an object to be observed, a second polarizing member for combining the two linearly polarized components on the same path after passing through the lens system, and a second polarizing element for converting a ray of light combined by the second polarizing member into linearly polarized light. At least one of the first polarizing member and the second polarizing member possesses the position of localized fringes at which the two linearly polarized components intersect with each other, and a distance from at least one polarizing member to the position of localized fringes is variable.

### BACKGROUND OF THE INVENTION

1. Field of the Invention

This invention relates to a differential interference optical system which is used in an optical microscope for observing a transparent specimen, such as a biological tissue, and a semiconductor or in a measuring apparatus for measuring a surface profile of a specimen.

2. Description of Related Art

FIG. 1 shows a conventional, transmission type differential interference optical system. In this differential interference optical system, a ray of light from an illumination source 1 is converted by a polarizer 2 into linearly polarized light and is split by a Wollaston prism 3 into two linearly polarized components vibrating perpendicular to each other. The two linearly polarized components travel with a slight separation angle, and are changed to parallel rays spaced some distance apart by the light-collecting behavior of a condenser lens 4 to enter an object 5 to be observed. The two linearly polarized components, after passing through the object 5, are collected on a Wollaston prism 7 by the light-collecting behavior of an objective lens 6 and are combined on the same path by the birefringent property of the Wollaston prism 7. The two linearly polarized components combined on the same path pass through an analyzer 8 and thereby interfere with each other so that the phase difference of the object 5 can be observed as the contrast between interference colors.

FIG. 2 shows a conventional, reflection type differential interference optical system. In this differential interference optical system, a ray of light from the illumination source 1 is converted into linearly polarized light by the polarizer 2 and its optical path is bent toward the object 5 by a half mirror 9 so that the ray of light is incident on the Wollaston prism 3. The linearly polarized light is split by the Wollaston prism 3 into two linearly polarized components vibrating perpendicular to each other, which are changed to parallel rays spaced some distance apart by the light-collecting behavior of the objective lens 6 to enter the object 5. The two linearly polarized components reflected from the object 5, after being collected again by the objective lens 6 and combined on the same path by the Wollaston prism 3, pass through the half mirror 9 and interfere with each other in the analyzer 8.

The Wollaston prism, as shown in FIG. 3, is such that two wedge-shaped prisms composed of birefringent crystals are cemented and an interface between them is inclined at an angle α with the surface of the prism. The optic axis of these wedge-shaped prisms is normal to an optical axis Z of the differential interference optical system and make right angles with each other. The Wollaston prism separates a ray of light incident on the interface into two linearly polarized components which vibrate perpendicular to each other and have a slight separation angle. In the Wollaston prism, when the surface of incidence is reversed, the linearly polarized components can be combined on the same path. The transmission type differential interference optical system shown in FIG. 1 is such that the Wollaston prism 3 is located at the position of the front focal point of the condenser lens 4 and thereby the two linearly polarized components separated by the Wollaston prism 3 is rendered parallel to enter the object 5. The Wollaston prism 7 is located at the position of the back focal point of the objective lens 6 so that the two linearly polarized components which emerge in parallel from the object 5 are combined on the same path.

Although reference has been made to the case where each of the focal points of the condenser lens 4 and the objective lens 6 is located outside the lens, cases are often met with, where an objective lens system is composed of a plurality of lenses and its back focal point lies inside the lens system. Since in such a case the Wollaston prism cannot be placed at the position of the focal point of the lens system, a Nomarski prism, such as that shown in FIG. 4, is used. The Nomarski prism, like the Wollaston prism, is such that two wedge-shaped prisms composed of birefringent crystals are cemented, but has the feature that the optic axis of one of the prisms is inclined at an angle β with the surface of the prism. In the Nomarski prism, an intersection A of two separated rays can be located outside the prism. The intersection A is a point where interference fringes produced by the Nomarski prism are seen most clearly and in this case, we call the intersection A the position of localized fringes. In the differential interference optical system, the Nomarski prism is often located so that the position of localized fringes coincides with the position of the back focal point of the objective lens.

In an optical microscope in which the differential interference optical system is often used, it is common practice to make observations by switching a plurality of objective lenses. Where objective lenses with different magnifications are switched and used, the focal lengths and back focal points of the objective lenses are different and thus it is necessary to provide corresponding Nomarski prisms on the objective side or the condenser side. In addition, where objective lenses with different back focal points are used even though they have the same magnification, corresponding Nomarski prisms must be provided. Hence, the differential interference system of the optical microscope includes various kinds of Nomarski prisms or Wollaston prisms.

A description will be given of the case where objective lenses with different back focal points are used in the transmission type differential interference optical system as shown in FIGS. 5A and 5B. FIG. 5A depicts the transmission type differential interference optical system arranged as in FIG. 1, in which like numerals are used for like members with respect to FIG. 1. In this figure, reference numerals 10 and 11 denote two kinds of objective lenses whose back focal points FB are different from each other and numeral 12 denotes a Nomarski prism, in which the optical paths of two linearly polarized components where the objective lens 10 is used are shown. FIG. 5B depicts the optical paths of two linearly polarized components where the objective lens 10 is switched over to the objective lens 11 whose magnification is the same as that of the objective lens 10 and whose back focal point FB is different therefrom. When the objective lens whose back focal point FB is different is used, the two linearly polarized components separated by the Wollaston prism 3 are not combined on the same path after passing through the Nomarski prism 12. This fails to bring about a differential interference effect.

To combine the two linearly polarized components on the same path after passing through the Nomarski prism 12 in the use of the objective lens 11, two techniques have been used in the past. One of these two techniques, instead of employing the Nomarski prism 12, is to employ a new Nomarski prism in which the position of localized fringes coincides with the back focal point of the objective lens 11. The other, instead of employing the Wollaston prism 3, is to employ a new Nomarski prism in which the two linearly polarized components separated in the use of the objective lens 11 are combined on the same path after passing through the Nomarski prism 12. Either of these techniques requires a new Nomarski prism when an objective lens with a different back focal point is used.

The Wollaston prism and the Nomarski prism, each having practically a thickness of 1 mm and a length of 20 mm and set in a frame with a thickness of about 3 mm, are expensive because birefringent crystals, such as quartz difficult of fabrication, must be fabricated with a high degree of accuracy. The variety of kinds of Nomarski prisms due to different back focal points of the objective lenses causes an increase in cost of the differential interference system.

In order to reduce the number of kinds of Nomarski prisms, it is only necessary to design a lens system so that the back focal points of the objective lenses coincide with one another. However, it is difficult to unify the back focal points of all the objective lenses. For example, objective lenses for microscopes are of types of achromat, semiapochromat, and apochromat, depending on correction for chromatic aberration. For applications, there are many kinds, for example, some lenses are used for fluorescence observations, others have super-working distances, and still others are provided with correction rings. The type of lens varies with the application. When the type of lens varies, the position of the back focal point is shifted, and thus it is difficult for lens design to unify the back focal points of the objective lenses that have a wide variety of applications.

The differential interference optical system using a plurality of objective lenses with different back focal point s, as mentioned above, has the problem that the cost of the differential interference system is increased due to an increase of the kind of prism. As one of techniques of solving this problem, a differential interference contrast microscope set forth in Japanese Utility Model No. 2593865 is proposed. The construction of this microscope is shown in FIGS. 6A and 6B. Specifically, two linearly polarized components vibrating perpendicular to each other, emerging from the object 5 intersect at the position of the back focal point of the objective lens 10, and are combined on the same path by the Nomarski prism 12. For the objective lens 11 with a different focal point, the Nomarski prism 12 is moved vertically so that the position of localized fringes of the Nomarski prism coincides with the position of the back focal point of the objective lens. This technique allows the objective lenses with different back focal points to be accommodated with one Nomarski prism, and the number of kinds of Nomarski prisms to be reduced.

As a technique that each of Wollaston prisms disposed in a condenser lens is used, irrespective of the interchange of the condenser lens, there is a differential interference contrast microscope set forth in Japanese Patent Publication No. Hei 8-509078. This microscope is constructed with an interchangeable condenser lens, a variety of Wollaston prisms mounted on a rotary disk which is placed in the condenser lens, and a plurality of objective lenses with different magnifications and focal lengths. Here, the interchangeable condenser lens is capable of using the same formula as in the plurality of objective lenses to find the focal length, and even when the condenser lens is interchanged, each Wollaston prism can be uses as it is.

In order to solve the above problem, a system such as that set forth in Japanese Patent Preliminary Publication No. Hei 11-218679 is also proposed.

The differential interference contrast microscope set forth in Utility Model No. 2593865 requires a wide space for vertical movement of the Nomarski prism because the Nomarski prism is moved vertically in accordance with a change in the back focal point of the objective lens. In general, the Nomarski prism on the objective side of the optical microscope is often placed in a revolver. In a limited space of the revolver, since the shift of the position of the back focal point of the objective lens produced corresponding to the vertical movement of the Nomarski prism is no more than 4-7 mm, it is impossible to accommodate the shift of the position of the back focal point of any objective lens, and the number of kinds of Nomarski prisms which can be reduced is limited. Moreover, this technique is to move the Nomarski prism itself to shift the position of localized fringes, and not to change a distance from the Nomarski prism to the position of localized fringes.

The differential interference contrast microscope set forth in Hei 8-509078 has no practical use because there is a limit to the focal length of the interchangeable condenser lens. The objective lenses have magnifications of 10×, 20×, and 40×, and focal lengths corresponding to these magnifications change in steps of ½. Hence, when the differential interference contrast microscope set forth in Hei 8-509078 is applied, the focal lengths of interchangeable condenser lenses are set in steps of ½. However, when the focal length of the condenser lens is shortened, this is advantageous for illumination with high numerical aperture, but there is the problem that an illumination range narrows. Since in the microscope the magnifications of the objective lenses range from 1× to 100× and the illumination range is considerably changed, it is difficult to set the focal lengths of the condenser lenses in steps of ½. As such, with the microscope of Hei 8509078, it is difficult to reduce the number of kinds of Nomarski prisms or Wollaston prisms.

### SUMMARY OF THE INVENTION

It is, therefore, an object of the present invention to provide a differential interference optical system which is capable of accommodating objective lenses with different back focal point s and is variable in a distance from a Wollaston prism or a Nomarski prism to the position of localized fringes, to reduce the number of kinds of Wollaston prisms or Nomarski prisms necessary for the differential interference optical system.

In order to achieve the above object, the differential interference optical system according to the present invention includes an illumination source, a first polarizing element for converting a ray of light emitted from the illumination source into linearly polarized light, a first polarizing member for separating the linearly polarized light converted by the first polarizing element into two linearly polarized components which vibrate perpendicular to each other and travel with a slight separation angle, a lens system for illuminating and observing an object to be observed, a second polarizing member for combining the two linearly polarized components on the same path after passing through the lens system, and a second polarizing element for converting a ray of light combined by the second polarizing member into linearly polarized light. At least one of the first polarizing member and the second polarizing member possesses the position of localized fringes at which the two linearly polarized components intersect with each other, and a distance from at least one polarizing member to the position of localized fringes is variable.

When at least one of the first polarizing member and the second polarizing member possesses the position of localized fringes, namely when either the first polarizing member or the second polarizing member, or both, possess the positions of localized fringes, identical polarizing members can be used for objective lenses with different back focal point s if a distance from the corresponding polarizing member to the position of localized fringes can be changed. Consequently, the number of kinds of Wollaston prisms or Nomarski prisms corresponding to the first polarizing member or the second polarizing member which is required for the differential interference optical system can be reduced.

According to the present invention, an angle made by the normal of the surface of at least one of the first polarizing member and the second polarizing member with the optical axis of the differential interference optical system is changed, and thereby the distance from the corresponding polarizing member to the position of localized fringes can be changed.

This and other objects as well as the features and advantages of the present invention will become apparent from the following detailed description of the preferred embodiments when taken in conjunction with the accompanying drawings.

### BRIEF DESCRIPTION OF THE DRAWINGS

FIG. 1 is a view showing a conventional, transmission type differential interference optical system;

FIG. 2 is a view showing a conventional, reflection type differential interference optical system;

FIG. 3 is a view showing the construction and function of a Wollaston prism;

FIG. 4 is a view showing the construction and function of a Nomarski prism; FIGS. 5A and 5B are views showing changes of optical paths of linearly polarized light where two objective lenses with different back focal point s are replaced with each other in the transmission type differential interference optical system;

FIGS. 6A and 6B are explanatory views showing essential parts of a conventional, differential interference microscope proposed to solve a problem where two objective lenses with different back focal point s are used;

FIGS. 7A and 7B are views for explaining the principle of the present invention;

FIG. 8 is a diagram showing a calculation example of a distance from a Nomarski prism to the position of localized fringes versus an angle made by the normal of the surface of the Nomarski prism with the optical axis;

FIGS. 9A and 9B are explanatory views showing separations of linearly polarized light by the Nomarski prism and a combination of a polarizing element with the Nomarski prism, respectively;

FIG. 10 is an explanatory view showing the separation of linearly polarized light by a single plane-parallel birefringent member;

FIG. 11 is an explanatory view showing the separation of linearly polarized light where two plane-parallel birefringent members are combined to eliminate the phase difference between two separated linearly polarized components;

FIGS. 12A and 12B are views for explaining an optical arrangement and function of a first embodiment in the present invention;

FIGS. 13A and 13B are views for explaining an optical arrangement and function of a second embodiment in the present invention;

FIGS. 14A and 14B are views for explaining an optical arrangement and function of a third embodiment in the present invention;

FIGS. 15A and 15B are views for explaining an optical arrangement and function of a fourth embodiment in the present invention;

FIGS. 16A and 16B are views for explaining an optical arrangement and function of a fifth embodiment in the present invention;

FIGS. 17A and 17B are views for explaining an optical arrangement and function of a sixth embodiment in the present invention;

FIGS. 18A and 18B are views for explaining the principle of a prism used in the present invention;

FIGS. 19A and 19B are views for explaining an optical arrangement and function of a seventh embodiment in the present invention;

FIGS. 20A and 20B are views for explaining an optical arrangement and function of an eighth embodiment in the present invention;

FIGS. 21A and 21B are views for explaining an optical arrangement and function of a ninth embodiment in the present invention;

FIGS. 22A and 22B are views for explaining an optical arrangement and function of a tenth embodiment in the present invention;

FIG. 23 is a view showing an example where the rotary axis of a polarizing member is set outside the polarizing member; and

FIG. 24 is a view showing an example where the rotary axis of the polarizing member intersects with the surface of the polarizing member.

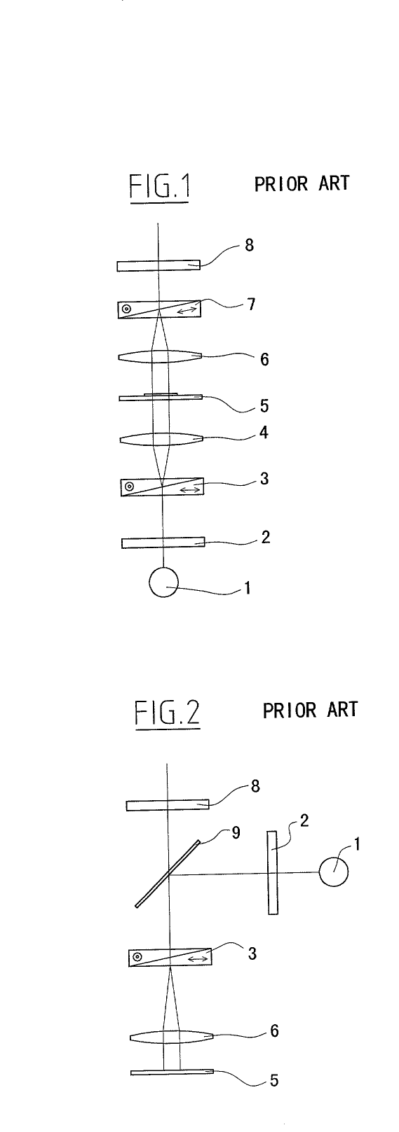

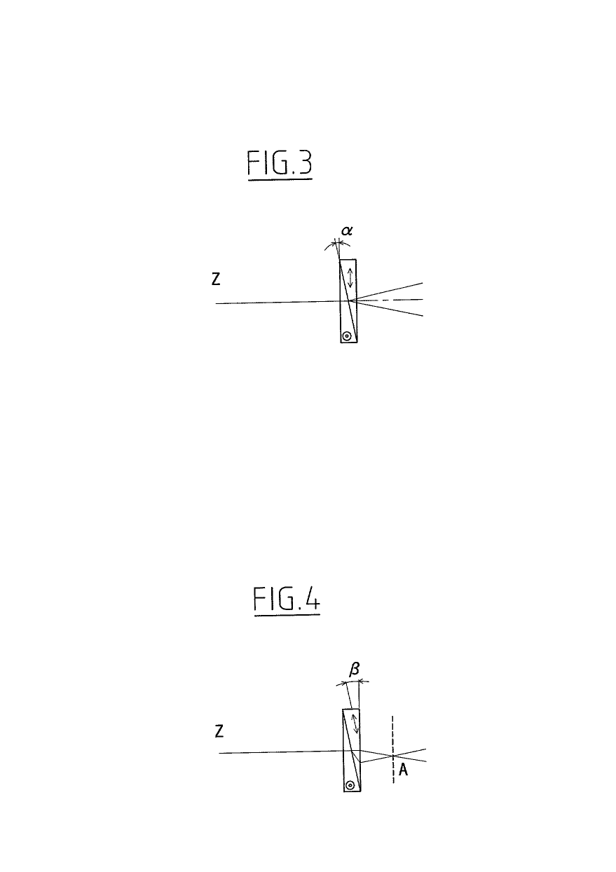

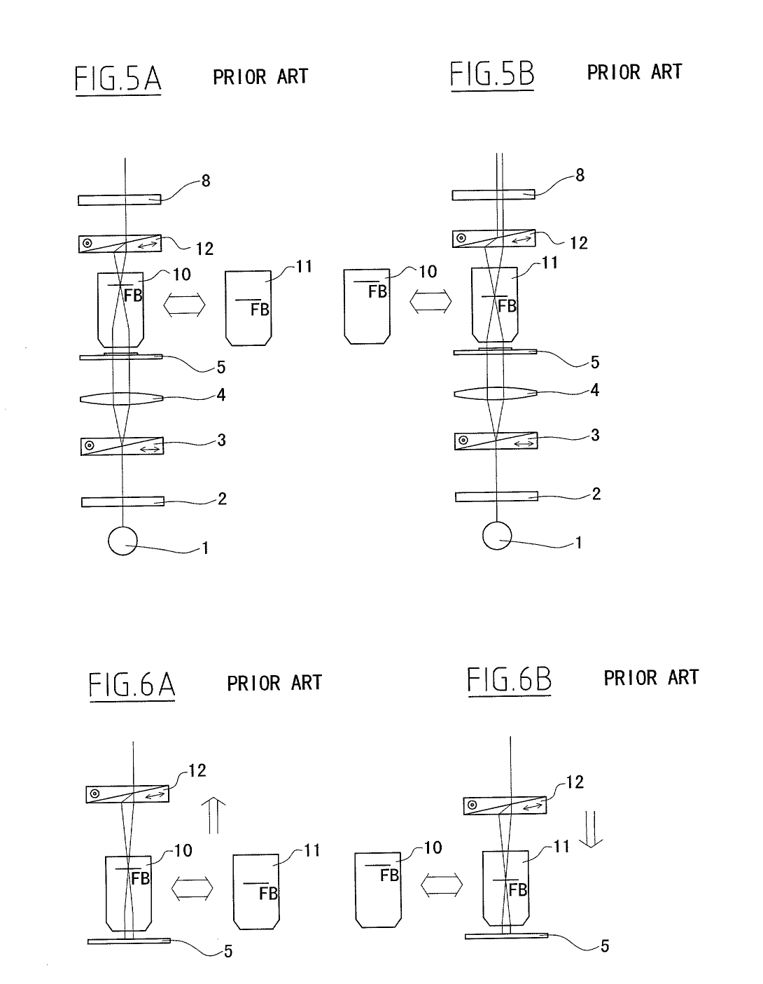

### DETAILED DESCRIPTION OF THE PREFERRED EMBODIMENTS

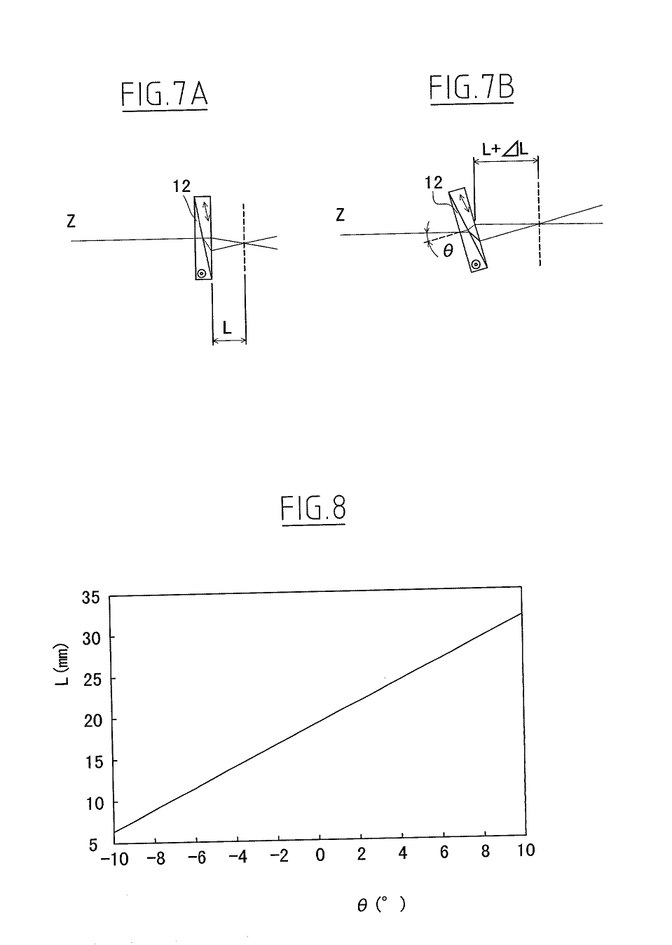

Usually, Nomarski prisms or Wollaston prisms are used as the first polarizing member and the second polarizing member in the differential interference optical system, but the present invention is not limited to this. Any optical member with a property of birefringence which separates an incident ray of light into two linearly polarized components vibrating perpendicular to each other and traveling with a slight separation angle can be used as the first polarizing member or the second polarizing member in the differential interference optical system. The optical member with the property of birefringence is such that the refractive index of an extraordinary ray varies with the traveling direction of the ray. Therefore, if the first polarizing member or the second polarizing member which is constructed with this optical member is inclined with respect to the optical axis of the differential interference optical system, the refractive index of the extraordinary ray will be changed and the position of localized fringes can be shifted. FIG. 7A shows the case where the normal of the surface of the Nomarski prism is parallel to the optical axis Z of the optical system. FIG. 7B shows the case where an angle θ is made by the normal of the surface of the Nomarski prism with the optical axis Z. Specifically, when the prism is inclined at the angle θ, a distance L from the prism to the position of localized fringes changes to a distance L+ΔL.

A calculation example of the distance L from the Nomarski prism to the position of localized fringes versus the angle θ made by the normal of the surface of the Nomarski prism with the optical axis is shown in FIG. 8. Here, the symbol θ is the angle between the optical axis of the optical system and the normal of the surface of the prism, measured in a counterclockwise direction. The Nomarski prism is such that its thickness is 1 mm, the wedge angle α is 10 minutes, and the angle β made with the optic axis is 10 degrees. In this prism, the angle made by the normal of the upper surface of the prism with the optical axis is held within ±10 degrees and the position of localized fringes is shifted by about 25 mm, so that it becomes possible to accommodate the shift of the position of the back focal point of the objective lens within this range. The calculation result relative to the Nomarski prism is shown in FIG. 8, but even with the Wollaston prism, the angle made by the normal of the surface of the prism with the optical axis is changed, and thereby the position of localized fringes can be shifted.

According to the present invention, the angle made by the normal of the surface of at least one of the first polarizing member and the second polarizing member with the optical axis of the differential interference optical system is changed, and at the same time, at least one polarizing member can be moved in a direction perpendicular to the optical axis of the differential interference optical system.

When at least one of the first polarizing member and the second polarizing member is inclined with respect to the optical axis of the differential interference optical system, the phase difference between two separated linearly polarized components vibrating perpendicular to each other is changed. For this reason, it is desirable that, by moving the inclined polarizing member in a direction perpendicular to the optical axis of the differential interference optical system, the phase difference between the two linearly polarized components is changed to cancel a phase difference caused by the inclination.

The differential interference optical system is often provided with a phase difference adjusting means for adjusting the phase difference between the two linearly polarized components. This is because the phase difference between the two linearly polarized components is changed and thereby the contrast of a differential interference contrast image can be changed. As the phase difference adjusting means, a means of moving the Nomarski prism in a direction perpendicular to the optical axis or a means of using a compensator is available.

When the phase difference adjusting means is the means of moving the Nomarski prism in a direction perpendicular to the optical axis, the inclined polarizing member can be moved by this adjusting means and thus a new moving means is not required.

On the other hand, when the phase difference adjusting means is a means of moving a Nomarski prism provided to be independent of the first polarizing member and the second polarizing member in a direction perpendicular to the optical axis or the means of using a compensator, the adjusting range of the phase difference adjusting means is set on the basis of the case where the phase difference between the two linearly polarized components is zero. Hence, if the inclined polarizing member is moved in a direction perpendicular to the optical axis of the differential interference optical system so that the phase difference between the two linearly polarized components is canceled, the adjusting range can be effectively used. By doing so, it becomes unnecessary to adjust the contrast through the phase difference adjusting means when the objective lens is switched.

According to the present invention, the first polarizing member or the second polarizing member is the Wollaston prism or the Nomarski prism.

According to the present invention, the Wollaston prism or the Nomarski prism is designed to satisfy the following condition:

|Δθ|×d<12 (1)

where d is the thickness of the prism, in millimeters, and Δθ is a variation of an angle made by the normal of the surface of the prism with the optical axis of the differential interference optical system, in degrees.

As mentioned above, when the Wollaston prism or the Nomarski prism is inclined, the position of localized fringes is shifted and at the same time, the phase difference between two separated linearly polarized components is increased. If the inclination of the prism is slight, the contrast can be adjusted by the phase difference adjusting means of the differential interference optical system. However, if it becomes considerable, the contrast can no longer be adjusted by the phase difference adjusting means. The phase difference between the two linearly polarized components in the Wollaston prism or the Nomarski prism is related to the thickness d of the prism, and as the thickness d is increased, the phase difference where the prism is inclined increases. In the present invention, the relation between the variation Δθ of the angle made by the normal of the surface of the Wollaston prism or the Nomarski prism with the optical axis and the thickness d of the prism is expressed by Condition (1) to restrict the amount of prism inclination.

It is desirable that the prism thickness d ≧0.5 mm. If the prism thickness is less than 0.5 mm, the surface accuracy of the prism will cease to be maintainable. An extremely large thickness of the prism will raise the above problem where the prism is inclined and the problem that it becomes difficult to place the prism between the objective lens and the revolver. It is thus desirable that the prism thickness is 0.5 mm or more.

According to the present invention, the first polarizing member or the second polarizing member includes only a first birefringent element with a property of birefringence, separating an incident ray of light into two linearly polarized components vibrating perpendicular to each other and traveling with a slight separation angle. Alternatively, it includes a combination of the first birefringent element with a second birefringent element which separates an incident ray of light into two linearly polarized components vibrating perpendicular to each other and causes them to emerge in parallel therefrom.

An example where the first polarizing member or the second polarizing member includes only the first birefringent element is as shown in FIGS. 7A and 7B already described. Thus, reference is made to an example where the first polarizing member or the second polarizing member includes a combination of the first birefringent element with the second birefringent element.

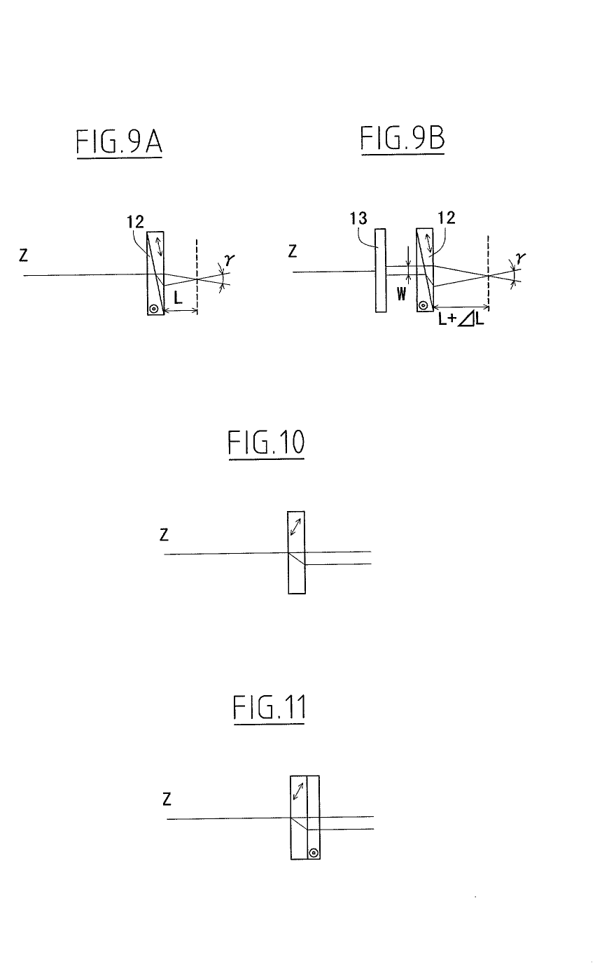

FIGS. 9A and 9B show the Nomarski prism 12 corresponding to the first birefringent element and a combination of the Nomarski prism 12 with a second birefringent element 13, respectively. FIG. 9A depicts the case where only the Nomarski prism 12 is placed. FIG. 9B depicts optical paths of linearly polarized components where the Nomarski prism 12 and the second birefringent element 13 placed before the prism 12 are arranged. In FIG. 9B, a ray of light, after passing through the second birefringent element 13, becomes two parallel linearly polarized components separated by a distance W, which are incident on the Nomarski prism 12 and emerge therefrom at a separation angle γ. In general, the wedge angle α and the separation angle γ of the Nomarski prism 12 are very small, and hence a shift ΔL of the position of localized fringes is expressed as follows:

ΔL=W/γ (2 )

In this way, by changing the ray separation W of the second birefringent element 13 placed before the Nomarski prism 12, it becomes possible to shift the position of localized fringes. In order to change the ray separation W of the second birefringent element 13, it is merely necessary to incline the second birefringent element 13 with respect to the optical axis or to provide a plurality of birefringent elements with different ray separations W to properly use one of them. In FIGS. 9A and 9B, the first birefringent element is shown as the Nomarski prism, but any optical element with the property of birefringence which separates an incident ray of light into two linearly polarized components vibrating perpendicular to each other and traveling with a slight separation angle is satisfactory.

According to the present invention, the second birefringent element includes at least one plane-parallel birefringent member.

FIG. 10 shows a single plane-parallel birefringent member as this example. This birefringent member is such that its optic axis is inclined with respect to a direction normal to the optical axis Z, and a ray of light, upon entering the birefringent member, is separated into two linearly polarized components, which emerge in parallel therefrom. With such a single birefringent member, the position of localized fringes produced by the ray separation can be shifted, but a phase difference arises between two separated linearly polarized components. Thus, when the second birefringent element is constructed with a single birefringent member, the contrast must be adjusted by the phase difference adjusting means. However, the fact that the second birefringent element can be constructed with a single birefringent member brings about the advantages that its fabrication and assembly are facilitated and cost can be reduced. In contrast to this, as shown in Fig. 11, a combination of the single birefringent member with another plane-parallel birefringent member, which cancels the phase difference between the two linearly polarized components, does not require that the contrast is adjusted by the phase difference adjusting means of the differential interference optical system.

According to the present invention, the differential interference optical system is a transmission type differential interference optical system in which the lens system for illuminating and observing an object to be observed includes an illumination lens system for illuminating the object and an objective lens system for observing the object.

According to present invention, the differential interference optical system is a reflection type differential interference optical system in which a separation of an incident ray of light into two linearly polarized components vibrating perpendicular to each other and traveling with a slight separation angle and a combination of the two linearly polarized components on the same path are achieved by one polarizing member. Specifically; in this case, the first polarizing member and the second polarizing member are not separately placed in the differential interference optical system. For example, only the first polarizing member is placed in the optical system, and the first polarizing member also performs the function of the second polarizing member.

The differential interference optical system according to the present invention has an illumination source, a first polarizing element for converting a ray of light from the illumination source into linearly polarized light, at least one polarizing member for separating an incident linearly polarized light into two linearly polarized components vibrating perpendicular to each other and traveling with a slight separation angle, a lens system for illuminating and observing an object to be observed, and a second polarizing element for converting incident rays of light into linearly polarized light. The polarizing member possesses the position of localized fringes at which the two linearly polarized components intersect with each other, and a distance from the polarizing member to the position of localized fringes is variable.

According to the above description, the differential interference optical system is designed so that it is applied to either the transmission type differential interference optical system or the reflection type differential interference optical system. The polarizing member, when rendering light incident from one side, functions as a polarization separating member for separating incident linearly polarized light into two linearly polarized components vibrating perpendicular to each other and traveling with a slight separation angle. However, when light is rendered incident from a reverse direction, it also functions as a polarization combining member for combining the two linearly polarized components vibrating perpendicular to each other and traveling with a slight separation angle. The transmission type differential interference optical system includes two polarization separating means; one, the polarization separating member and the other, the polarization combining member. The reflection type differential interference optical system includes only one polarizing member, which is used as the polarization separating member, and the polarization combining member as well.

According to the present invention, at least one of the first polarizing member and the second polarizing member includes a plurality of polarizing members, which are different in angle made by the normal of the surface of the polarizing member with the optical axis of the differential interference optical system.

As mentioned above, where an angle made by the normal of the surface of the polarizing member with the optical axis of the differential interference optical system is changed by a single polarizing member, a mechanism is required therefor. However, when a plurality of polarizing members are provided, the position of localized fringes can be shifted by replacing these members. As such, the above mechanism and space for it become unnecessary.

According to the present invention, each of the first polarizing member and the second polarizing member includes a combined body having two wedge-shaped prisms cemented to each other so that at least one of the members is rotated around a preset rotary axis. Whereby, the distance from the polarizing member to the position of localized fringes can be changed. Here, the preset rotary axis lies in a plane including the optical axis and the normal of an interface between the two wedge-shaped prisms.

The first polarizing member or the second polarizing member can also be set into rotation in a state where it is placed on the optical path. However, the optical elements, such as the objective lens and the condenser lens, are generally arranged in the vicinity of the polarizing member, and therefore it is difficult to hold a space for rotating the polarizing member.

It is thus desirable that each of the first polarizing member and the second polarizing member is supported on a plate-shaped holding member so that it is moveable in and out of the optical path. By doing so, when the objective lens is replaced, the holding member is removed once from the optical path and can be rotated around the rotary axis. Then, the holding member is inserted again in the optical path by turning the member upside down. Consequently, it is merely necessary to consider a space required in the optical path with respect to only the thickness of the holding member.

According to the present invention, each of the first polarizing member and the second polarizing member includes a combined body having two wedge-shaped prisms cemented to each other so that at least one of the members can be switched to one of a plurality of third polarizing members including combined bodies, each having two wedge-shaped prisms cemented to each other. In this case, where the first polarizing member is switched to the third polarizing member, the third polarizing member is equivalent to the first polarizing member which is rotated 180° around a preset rotary axis. Similarly, where the second polarizing member is switched to the third polarizing member, the third polarizing member is equivalent to the second polarizing member which is rotated 180° around the preset rotary axis. Here, the preset rotary axis lies in a plane including the optical axis and the normal of an interface between the two wedge-shaped prisms.

Also, in practical use, it is only necessary that the first polarizing member and the third polarizing member, or the second polarizing member and the third polarizing member, are supported by separate holding members and one of them is inserted in or removed from the optical path according to working conditions. The first polarizing member and the third polarizing member, or the second polarizing member and the third polarizing member, can also be previously placed on the same holding member so that the holding member is moved along the optical path. In this case, a conventional, well known means, such as a slider or turret, may be utilized.

In accordance with the embodiments shown in the drawings, the present invention will be described below. In the embodiments, like numerals are used for like optical members with respect to the prior art examples.

First Embodiment

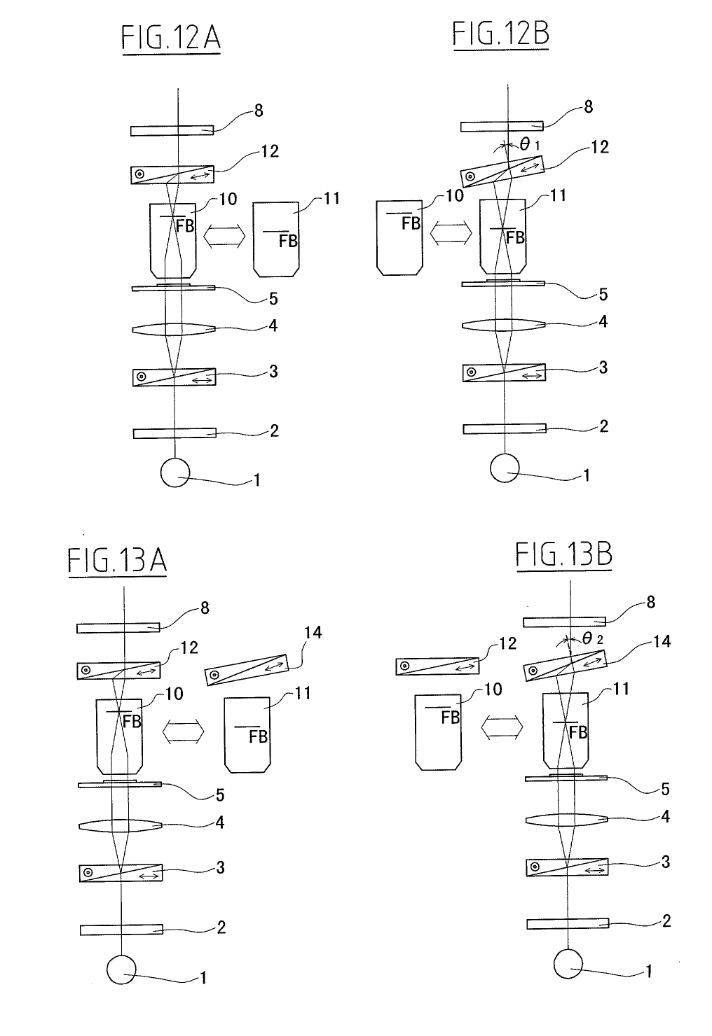

FIGS. 12A and 12B show identical transmission type differential interference optical systems in which the objective lenses 10 and 11 with different back focal points FB are used, respectively, in the first embodiment of the present invention. Specifically, in FIG. 12A, the objective lens 10 is inserted in the optical path, and a ray of light from the illumination source 1 is converted by the polarizer 2 into linearly polarized light, which is incident on the Wollaston prism 3 and then is separated into two linearly polarized components vibrating perpendicular to each other. The two linearly polarized components are rendered nearly parallel by the light-collecting behavior of the condenser lens 4 and are incident on the object 5 to be observed. The two linearly polarized components are collected at the back focal point FB of the objective lens 10, and after being combined on the same path by the Nomarski prism 12, are caused to interfere by the analyzer 8. The Nomarski prism 12 is constructed so that an angle made by the normal of the surface of the prism with the optical axis of the differential interference optical system can be changed. As shown in FIG. 12B, where the objective lens 11 with a different back focal point FB is inserted in the optical path, the Nomarski prism 12 is inclined at an angle θ₁. By changing the angle made by the normal of the surface of the Nomarski prism 12 with the optical axis of the optical system, the same Nomarski prism can be used for the objective lenses with different back focal points.

When the Nomarski prism 12 is inclined, it is desirable that the Nomarski prism 12 is turned, with its center of rotation at the position where the phase difference between two linearly polarized components caused by the Nomarski prism 12 becomes zero. Here, because the differential interference optical system shown in each of FIGS. 12A and 12B is of a transmission type, the center of rotation of the Nomarski prism 12 is located at the position where it is assumed that linearly polarized light is rendered incident from the direction of the analyzer 8 and the phase difference between two linearly polarized components produced in this case becomes zero. In this way, when the Nomarski prism 12 is rotated, with its center of rotation at the position where the phase difference between the two linearly polarized components becomes zero, the phase difference produced between the two linearly polarized components can be kept to a minimum even though the Nomarski prism 12 is inclined with respect to the optical axis of the differential interference optical system.

The center of rotation can also be set at a point where the normal of the surface of the Nomarski prism 12 is inclined at a predetermined angle with respect to the optical axis of the differential interference optical system and at the same time, the Nomarski prism 12 itself is moved in a direction normal to the optical axis of the differential interference optical system. For example, there is a point lying on the optical axis of the differential interference optical system, other than a point where the interface between two wedges of the Nomarski prism 12 intersects with the optical axis of the differential interference optical system.

By doing so, even when the Nomarski prism 12 is inclined at a predetermined angle with respect to the optical axis of the differential interference optical system and thereby the phase difference is produced between the two linearly polarized components, the Nomarski prism 12 itself is moved in a direction normal to the optical axis of the optical system, and thus the phase difference produced between the two linearly polarized components can be kept to a minimum.

Second Embodiment

FIGS. 13A and 13B show the second embodiment of the present invention relative to the transmission type differential interference optical system. In this embodiment also, the two objective lenses 10 and 11 with different back focal points are used. In FIG. 13A, the objective lens 10 is inserted in the optical path, and a ray of light from the illumination source 1 is converted by the polarizer 2 into linearly polarized light, which is incident on the Wollaston prism 3 and then is separated into two linearly polarized components vibrating perpendicular to each other. The two linearly polarized components are rendered nearly parallel by the light-collecting behavior of the condenser lens 4 and are incident on the object 5 to be observed. The two linearly polarized components are collected at the back focal point FB of the objective lens 10, and after being combined on the same path by the Nomarski prism 12, are caused to interfere by the analyzer 8. As shown in FIG. 13B, where the objective lens 11 with a different back focal point FB is inserted in the optical path, a Nomarski prism 14 which is the same as the Nomarski prism 12 used in FIG. 13A and in which the normal of the surface of the prism is inclined at an angle θ₂ with respect to the optical axis of the optical system is also inserted in the optical path. The second embodiment dispenses with the mechanism for changing the angle made by the normal of the surface of the Nomarski prism with the optical axis of the optical system which is necessary for the first embodiment. Although in the second embodiment the Nomarski prism 12 is required in accordance with the kind of objective lens, it is only necessary that a combination of wedge-shaped optical members constituting the Nomarski prism 12 is of one kind, and there is no need to make wedges with various angles. Hence, a plurality of costly tools required for wedge fabrication need not be provided.

Third Embodiment

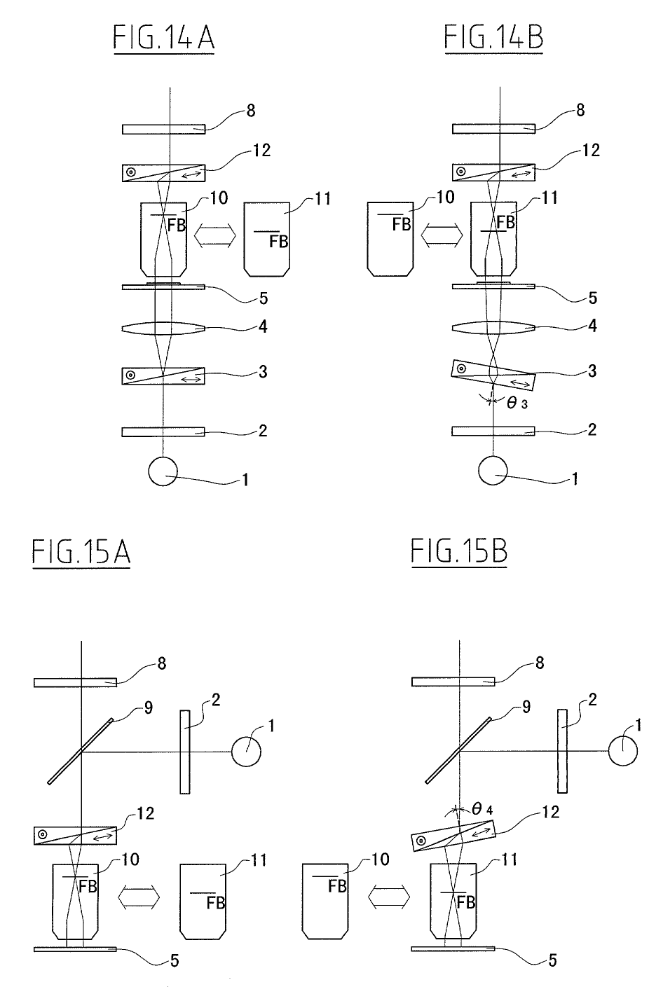

FIGS. 14A and 14B show the third embodiment of the present invention relative to the transmission type differential interference optical system. In this embodiment also, the two objective lenses 10 and 11 with different back focal points are used. In FIG. 14A, the objective lens 10 is inserted in the optical path, and a ray of light from the illumination source 1 is converted by the polarizer 2 into linearly polarized light, which is incident on the Wollaston prism 3 and then is separated into two linearly polarized components vibrating perpendicular to each other. The two linearly polarized components are rendered nearly parallel by the light-collecting behavior of the condenser lens 4 and are incident on the object 5 to be observed. The two linearly polarized components are collected at the back focal point FB of the objective lens 10, and after being combined on the same path by the Nomarski prism 12, are caused to interfere by the analyzer 8. The third embodiment is constructed so that an angle made by the normal of the surface of the Wollaston prism 3 with the optical axis of the differential interference optical system can be changed. As shown in FIG. 14B, where the objective lens 11 with a different back focal point FB is inserted in the optical path, the Wollaston prism 3 is used in a state where the surface of the prism is inclined at an angle θ₃ with respect to the optical axis of the optical system. In the third embodiment, as in the second embodiment, where the objective lens 11 with a different back focal point FB is inserted in the optical path, another Wollaston prism which is the same as the Wollaston prism 3 and in which the normal of the surface of the prism is inclined at an angle θ₃ with the optical axis of the optical system may be inserted in the optical path in replacement of the Wollaston prism 3.

Fourth Embodiment

FIGS. 15A and 15B show the fourth embodiment of the present invention relative to the reflection type differential interference optical system. In this embodiment also, the two objective lenses 10 and 11 with different back focal points are used. In FIG. 15A, the objective lens 10 is inserted in the optical path, and a ray of light from the illumination source 1 is converted by the polarizer 2 into linearly polarized light, whose optical path is bent toward the object by the half mirror 9 and enters the Nomarski prism 12. The linearly polarized light is separated by the Nomarski prism 12 into two linearly polarized components vibrating perpendicular to each other, which are rendered parallel by the light-collecting behavior of the objective lens 10 and are incident on the object 5. The two linearly polarized components reflected from the object 5 are collected again by the objective lens 10, and after being combined on the same path by the Nomarski prism 12, pass through the half mirror 9 to interfere in the analyzer 8. The Nomarski prism 12 is constructed so that an angle made by the normal of the surface of the prism with the optical axis of the differential interference optical system can be changed. As shown in FIG. 15B, where the objective lens 11 with a different back focal point is inserted in the optical path, the Nomarski prism 12 is used in such a way that it is inclined at angle θ₄. In the reflection type differential interference optical system as well, the angle made by the normal of the surface of the Nomarski prism with the optical axis of the optical system is changed and thereby the same Nomarski prism can be used for the objective lenses with different focal points.

Fifth Embodiment

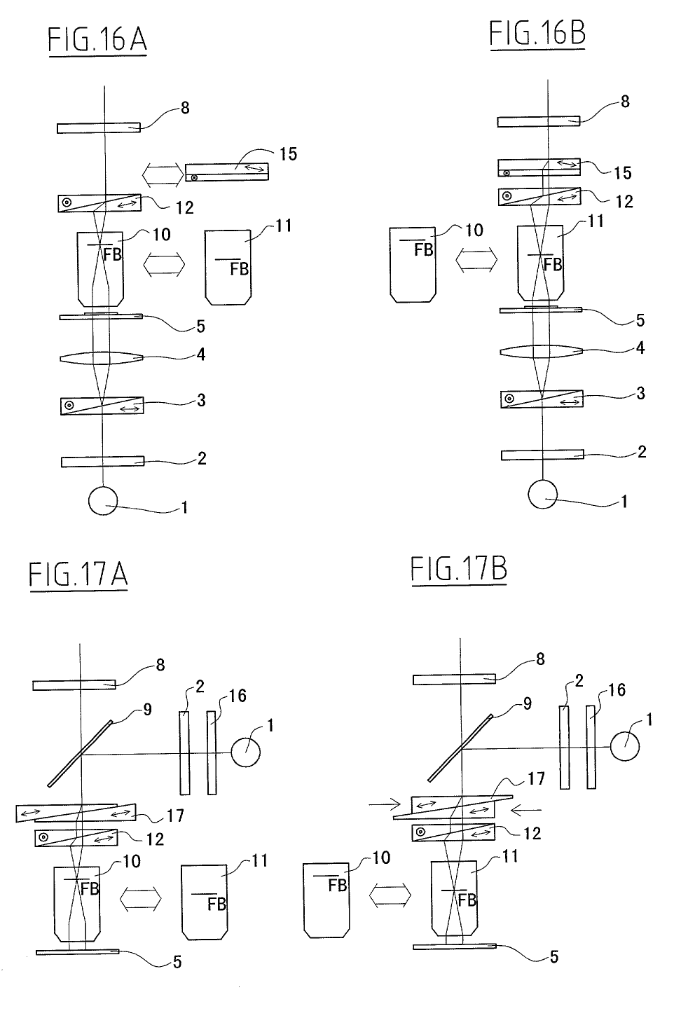

FIGS. 16A and 16B show the fifth embodiment of the present invention relative to the transmission type differential interference optical system. This embodiment uses a polarization optical element which separates an incident ray of light into two linearly polarized components vibrating perpendicular to each other and causes them to emerge in parallel. In the fifth embodiment also, the two objective lenses 10 and 11 with different back focal points are used. In FIG. 16A, the objective lens 10 is inserted in the optical path, and a ray of light from the illumination source 1 is converted by the polarizer 2 into linearly polarized light, which is incident on the Wollaston prism 3 and then is separated into two linearly polarized components vibrating perpendicular to each other. The two linearly polarized components are rendered nearly parallel by the light-collecting behavior of the condenser lens 4 and are incident on the object 5 to be observed. The two linearly polarized components are collected at the back focal point FB of the objective lens 10, and after being combined on the same path by the Nomarski prism 12, are caused to interfere by the analyzer 8. Where the objective lens 11 with a different back focal point is used, as shown in FIG. 16B, a prism 15 composed of two plane-parallel birefringent members cemented to each other is inserted in the optical path between the Nomarski prism 12 and the analyzer 8. The prism 15 separates an incident ray of light into two linearly polarized components vibrating perpendicular to each other and causes the components to emerge in parallel. The amount of its separation corresponds to a difference between the back focal points FB of the objective lenses 10 and 11 according to Eq. (2). The two plane-parallel plates of the prism 15 are such that the phase difference becomes zero with respect to the two linearly polarized components, and it is not required that the contrast of the differential interference optical system is adjusted by the phase difference adjusting means when the objective lens is switched.

Sixth Embodiment

FIGS. 17A and 17B show the sixth embodiment of the present invention relating to the reflection type differential interference optical system. In this embodiment also, the two objective lenses 10 and 11 with different back focal points are used. In FIG. 17A, the objective lens 10 is inserted in the optical path, and a ray of light from the illumination source 1 passes through a band-pass filter 16 and is converted into quasi-monochromatic light. This quasi-monochromatic light is converted by the polarizer 2 into linearly polarized light, whose optical path is bent toward the object by the half mirror 9 and enters a pair of wedge-shaped birefringent crystals 17. The pair of wedge-shaped birefringent crystals 17, each of which can be moved in a direction perpendicular to the optical axis of the differential interference optical system, is capable of changing the amount of separation between two linearly polarized components vibrating perpendicular to each other. The linearly polarized light is separated by the pair of wedge-shaped birefringent crystals 17 into two linearly polarized components vibrating perpendicular to each other, which are incident on the Nomarski prism 12. By the birefringent behavior of the Nomarski prism 12, the two linearly polarized components are collected at the back focal point FB of the objective lens 10, and are rendered parallel by the light-collecting behavior of the objective lens 10 to enter the object 5. The two linearly polarized components reflected from the object 5 are collected again by the objective lens 10, and after being combined on the same path by the Nomarski prism 12 and the pair of wedge-shaped birefringent crystals 17, pass through the half mirror 9 to interfere in the analyzer 8. Where the objective lens 11 with a different back focal point FB is inserted in the optical path, as shown in FIG. 17B, each of the pair of wedge-shaped birefringent crystals 17 is moved in a direction normal to the optical axis of the optical system, and the amount of separation of polarization is changed in accordance with a difference between the back focal points of the objective lenses 10 and 11 on the basis of Eq. (2). Consequently, a differential interference observation can be carried out.

In the sixth embodiment, observations are made with the quasi-monochromatic light so that the contrast of the differential interference optical system can be adjusted even when the amount of phase difference adjustment of the phase difference adjusting means of the optical system is in the range from 0 to 2π. This is because the phase difference between the two linearly polarized components produced by the pair of wedge-shaped birefringent crystals 17 increases and the phase difference adjustment by the phase difference adjusting means of the optical system cannot be made through white light observation. The phase difference adjusting means is not shown in FIGS. 17A and 17B, but if, for example, a mechanism for moving the Nomarski prism 12 in a direction normal to the optical axis of the optical system is available, the phase difference adjustment becomes possible.

In any of the above embodiments, the objective lenses with different back focal points are used, but the present invention is effective for the case where condenser lenses with different back focal points are used. In this case also, the differential interference observation can be carried out by changing an angle made by the normal of the surface of the Nomarski prism on the objective side or the Wollaston prism on the condenser side with the optical axis of the optical system, or by introducing the polarization optical element, into the optical path, which separates an incident ray of light into two linearly polarized components vibrating perpendicular to each other and causes the polarized components to emerge in parallel.

In any of the above embodiments, the Nomarski prism, the Wollaston prism, or the prism composed of two plane-parallel birefringent members cemented to each other is moved in a direction perpendicular to the optical axis of the differential interference optical system in accordance with the changeover of the objective lens with a different back focal point. According to the present invention, however, in response to the changeover of the objective lens, the Nomarski prism or the Wollaston prism as the polarizing member is rotated 180° around a rotary axis lying in a plane including the optical axis of the differential interference optical system and the normal of an interface between the two wedge-shaped prisms constituting the polarizing member, and thereby the object of the present invention can also be achieved.

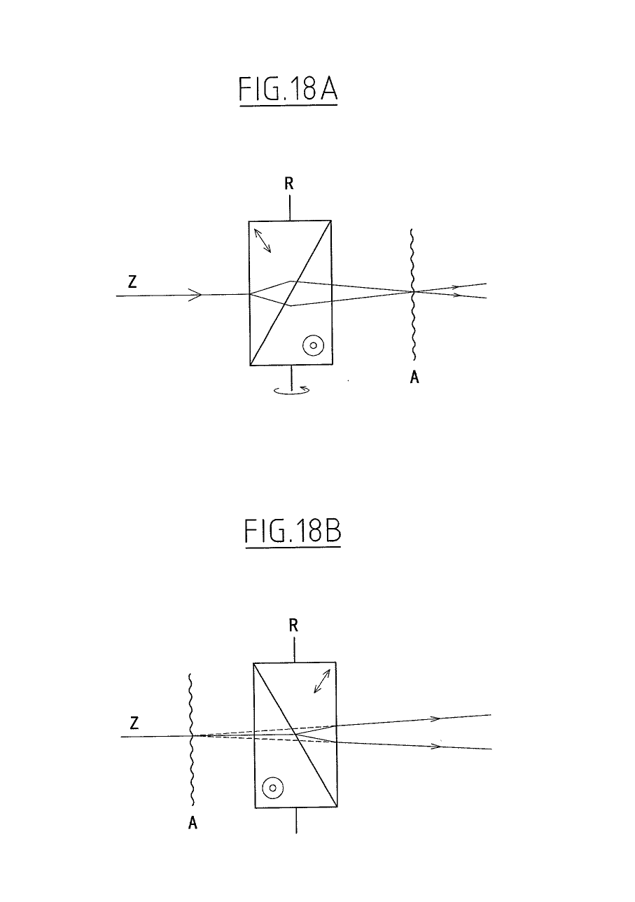

FIGS. 18A and 18B show the positions of localized fringes where the Nomarski prism or the Wollaston prism as the first or second polarizing member is rotated 180° around a rotary axis R which lies in a plane including the optical axis Z of the differential interference optical system and the normal of an interface between the two wedge shaped prisms constituting the Nomarski prism or the Wollaston prism and is parallel to the surface of the Nomarski prism or the Wollaston prism. FIG. 18A illustrates a state where the prism is located at a first position before rotation (the position of localized fringes lies on the right side of the prism). FIG. 18B illustrates a state where the prism is rotated 180° around the rotary axis R from the first position to rest at a second position (the position of localized fringes lies on the left side of the prism). Here, a description will be given of embodiments according to this technique.

Seventh Embodiment

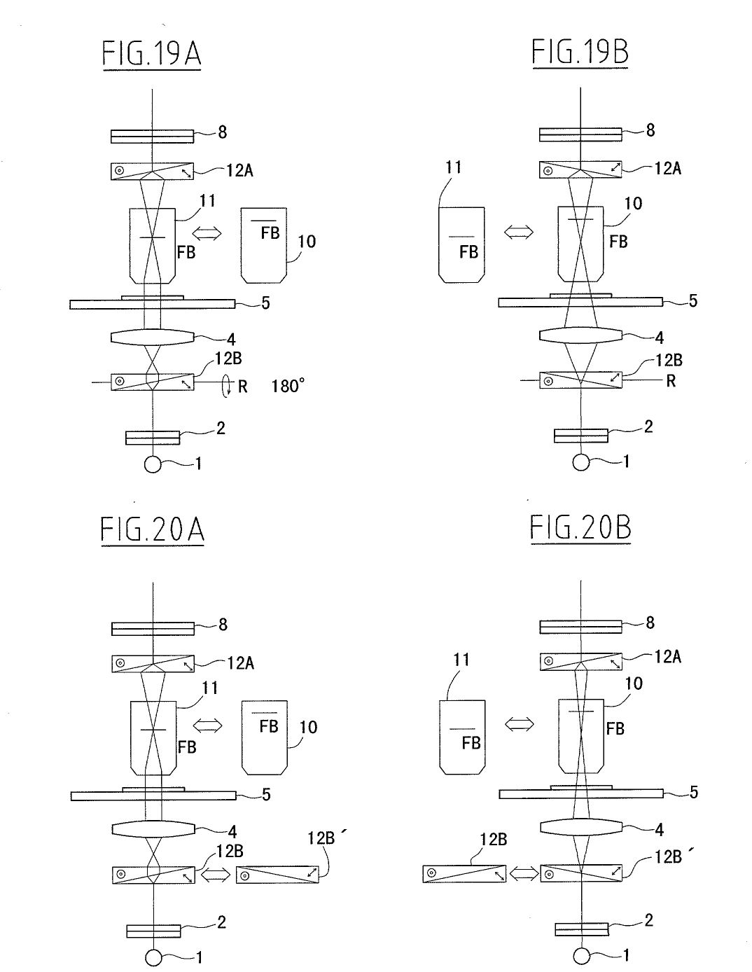

FIGS. 19A and 19B show the seventh embodiment of the present invention relating to the transmission type differential interference optical system. In this embodiment also, the two objective lenses 10 and 11 with different back focal points are used. In FIG. 19A, the objective lens 11 is inserted in the optical path and a ray of light from the illumination source 1 is converted by the polarizer 2 into linearly polarized light, which is incident on a Nomarski prism 12B located at the first position and then is separated into two linearly polarized components vibrating perpendicular to each other. The two linearly polarized components are rendered nearly parallel by the light-collecting behavior of the condenser lens 4 and are incident on the object 5 to be observed. The two linearly polarized components are collected at the back focal point FB of the objective lens 11, and after being combined on the same path by a Nomarski prism 12A, are caused to interfere by the analyzer 8. The Nomarski prism 12B is designed so that it can be rotated 180° around the rotary axis R which lies in a plane including the optical axis of the optical system and the normal of the interface between the two wedge-shaped prisms constituting the Nomarski prism 12B and is parallel to the surface of the Nomarski prism 12B. As shown in FIG. 19B, when the objective lens 10 whose back focal point FB is different is inserted in the optical path, the Nomarski prism 12B is rotated 180° around the rotary axis R, and thereby can be used to accommodate this objective lens.

Eighth Embodiment

FIGS. 20A and 20B show the eighth embodiment of the present invention relative to the transmission type differential interference optical system. This embodiment has the same arrangement as in the seventh embodiment with the exception that when the objective lens 11 is replaced by the objective lens 10, the Nomarski prism 12B is not rotated 180°, but another Nomarski prism 12B′ provided in a state where it is previously rotated 180° is inserted in the optical path. That is, FIG. 20A illustrates a case where the objective lens 11 and the Nomarski prism 12B are inserted in the optical path, and FIG. 20B illustrates a case where the objective lens 10 and the Nomarski prism 12B′ are inserted in the optical path. According to the eighth embodiment, a mechanism for rotating the Nomarski prism 12B becomes unnecessary, and thus there is the advantage that the construction of the optical system is simplified to reduce its cost. Also, in this case, the Nomarski prism 12B may be rotated, without providing the Nomarski prism 12B′.

Ninth Embodiment

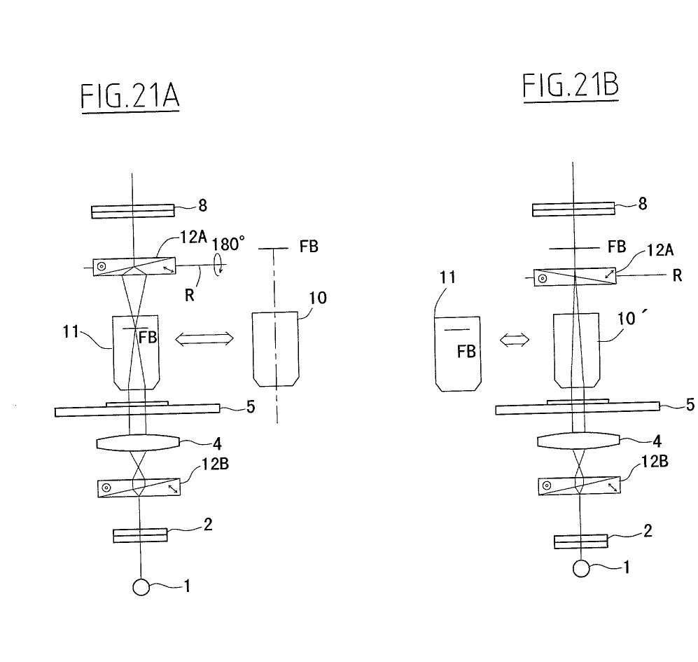

FIGS. 21A and 21B show the ninth embodiment of the present invention relating to the transmission type differential interference optical system. This embodiment is constructed so that the Nomarski prism 12A can be rotated 180° around the rotary axis R which lies in a plane including the optical axis of the optical system and the normal of the interface between the two wedge-shaped prisms constituting the Nomarski prism 12A and is parallel to the surface of the Nomarski prism 12A. As shown in FIG. 21B, when an objective lens 10′ with low magnification (for example, of 2×) such that the back focal point FB is located outside the objective lens is inserted in the optical path, the Nomarski prism 12A is rotated 180° around the rotary axis R, and thereby can be used to accommodate this objective lens.

Tenth Embodiment

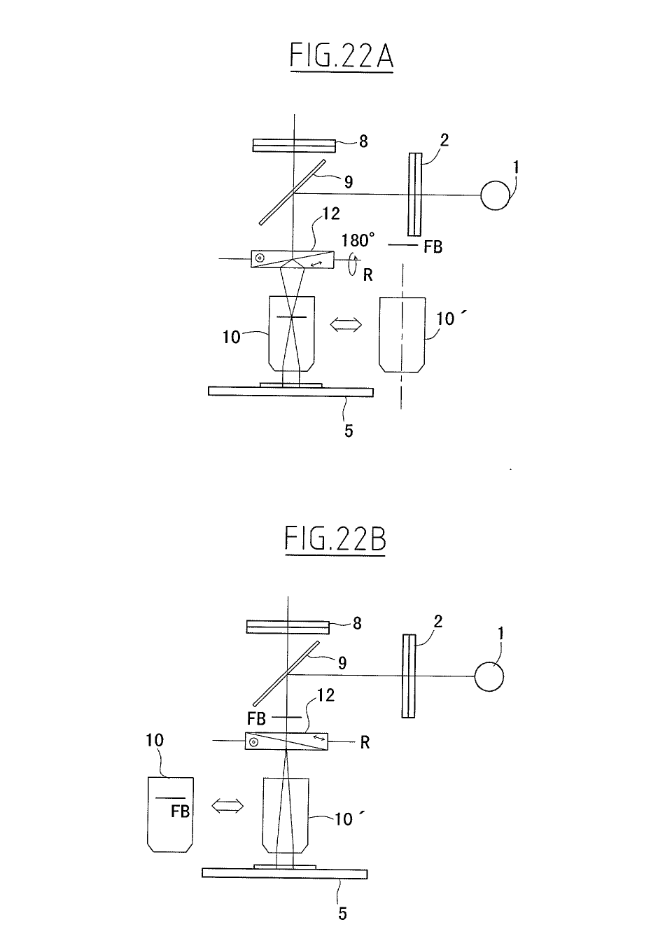

FIG. 22A and 22B show the tenth embodiment of the present invention relating to the reflection type differential interference optical system. This embodiment is also constructed so that the Nomarski prism 12 can be rotated 180° around the rotary axis R which lies in a plane including the optical axis of the optical system and the normal of the interface between the two wedge-shaped prisms constituting the Nomarski prism 12 and is parallel to the surface of the Nomarski prism 12. As shown in FIG. 22B, when an objective lens 10′ with low magnification (for example, of 2×) such that the back focal point FB is located outside the objective lens is inserted in the optical path, the Nomarski prism 12 is rotated 180° around the rotary axis R, and thereby can be used to accommodate this objective lens.

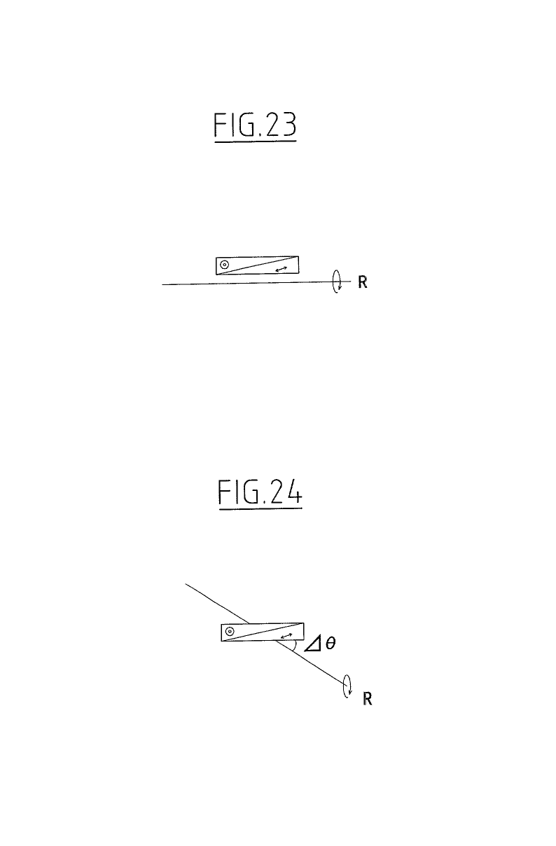

In any of the seventh to tenth embodiments mentioned above, the Nomarski prism, used as the polarizing member, can be rotated 180° around the rotary axis R which lies in a plane including the optical axis of the optical system and the normal of the interface between the two wedge-shaped prisms constituting the Nomarski prism and is parallel to the surface, and goes through the center, of the Nomarski prism. However, the rotary axis R, as shown in FIG. 23, may be set outside the Nomarski prism, without going through the center of the Nomarski prism. Alternatively, the rotary axis R, as shown in FIG. 24, may also be set to make the angle Δθ satisfying Condition (1) with the surface of the Nomarski prism. Moreover, the Nomarski prism may be constructed so that the Nomarski prism, after being rotated 180° around the rotary axis R having the above condition, is inclined at the angle Δθ satisfying Condition (1). According to this construction, the back focal point of the objective lens can be set in a wide range. In the seventh to tenth embodiments mentioned above, the Nomarski prism is used as the polarizing member, but instead of this, the Wollaston prism can also be used. The function and effect in this case are the same as in the Nomarski prism. For the polarizing member, a combination of the Nomarski prism with an optical member (such as a prism) may be used.

What is claimed is:

1. A differential interference optical system comprising:
an illumination source;
a first polarizing element for converting a ray of light emitted from said illumination source into linearly polarized light;
a first polarizing member for separating said linearly polarized light converted by said first polarizing element into two linearly polarized components which vibrate perpendicular to each other and travel at a slight separation angle;
a lens system for illuminating and observing an object to be observed;
a second polarizing member for combining said two linearly polarized components on an identical path after passing through said lens system; and
a second polarizing element for converting a ray of light combined by said second polarizing member into linearly polarized light,
wherein at least one polarizing member of said first polarizing member and said second polarizing member possesses a position of localized fringes at which said two linearly polarized components intersect with each other, and a distance from said at least one polarizing member to said position of localized fringes is variable.

2. A differential interference optical system according to claim 1, wherein an angle made by a normal of a surface of said at least one polarizing member with an optical axis of said differential interference optical system is changed and thereby said distance from said at least one polarizing member to said position of localized fringes can be changed.

3. A differential interference optical system according to claim 1, wherein each of said first polarizing member and said second polarizing member includes a combined body having two wedge-shaped prisms cemented to each other so that at least one polarizing member of said first polarizing member and said second polarizing member is rotated 180° around a rotary axis lying in a plane including an optical axis and a normal of an interface between said two wedge-shaped prisms, and thereby a distance from said at least one polarizing member to a position of localized fringes can be changed.

4. A differential interference optical system according to claim 1, wherein each of said first polarizing member and said second polarizing member includes a combined body having two wedge-shaped prisms cemented to each other so that at least one of said first polarizing member and said second polarizing member can be switched to one of a plurality of third polarizing members including combined bodies, each having two wedge-shaped prisms cemented to each other, and a switched polarizing member of said third polarizing members is rotated 180° around a rotary axis lying in a plane including an optical axis and a normal of an interface between said two wedge-shaped prisms and thereby a distance from said switched polarizing member to said position of localized fringes can be changed.

5. A differential interference optical system according to claim 2, wherein an angle made by said normal of said surface of said at least one polarizing member with said optical axis of said differential interference optical system is changed, and said at least one polarizing member is moved in a direction perpendicular to said optical axis of said differential interference optical system.

6. A differential interference optical system according to claim 2, wherein said first polarizing member or said second polarizing member is a Wollaston prism or a Nomarski prism.

7. A differential interference optical system according to claim 6, wherein one of said Wollaston prism and said Nomarski prism is constructed to satisfy the following condition:

|66 θ|×d<12
where d is a thickness of said prism, in millimeters, and Δ74 is a variation of an angle made by a normal of a surface of said prism with said optical axis of said differential interference optical system, in degrees.

8. A differential interference optical system according to claim 1, wherein one of said first polarizing member and said second polarizing member includes only a first birefringent element with a property of birefringence, separating an incident ray of light into two linearly polarized components vibrating perpendicular to each other and traveling at a slight separation angle, or a combination of said first birefringent element with a second birefringent element which separates an incident ray of light into two linearly polarized components vibrating perpendicular to each other so that said two linearly polarized components emerge in parallel therefrom.

9. A differential interference optical system according to claim 8, wherein said second birefringent element has at least one plane-parallel birefringent member.

10. A differential interference optical system according to claim 8, wherein said first polarizing member or said second polarizing member is a Wollaston prism or a Nomarski prism.

11. A differential interference optical system according to claim 1, wherein said lens system for illuminating and observing an object to be observed includes an illumination lens system for illuminating said object and an objective lens system for observing said object.

12. A differential interference optical system according to claim 1, wherein a separation of an incident ray of light into two linearly polarized components vibrating perpendicular to each other and traveling at a slight separation angle and a combination of said two linearly polarized components on an identical path are achieved by one polarizing member.

13. A differential interference optical system comprising:
an illumination source;
a first polarizing element for converting a ray of light from said illumination source into linearly polarized light;
at least one polarizing member for separating an incident linearly polarized light into two linearly polarized components vibrating perpendicular to each other and traveling at a slight separation angle;
a lens system for illuminating and observing an object to be observed; and
a second polarizing element for converting incident rays of light into linearly polarized light,
wherein said at least one polarizing member possesses a position of localized fringes at which said two linearly polarized components intersect with each other, and a distance from said at least one polarizing member to the position of localized fringes is variable.

14. A differential interference optical system according to claim 2, wherein said at least one polarizing member includes a plurality of polarizing members, and said plurality of polarizing members are different in angle made by a normal of a surface of said at least one polarizing member with an optical axis of said differential interference optical system.

15. A differential interference optical system according to claim 2, wherein said at least one polarizing member is turned, with a center of rotation at a position where a phase difference between said two linearly polarized components caused by said at least one polarizing becomes zero.

16. A differential interference optical system according to claim 2, wherein said at least one polarizing member is turned, with a center of rotation at a point where a normal of a surface of said at least one polarizing member is inclined at a predetermined angle with respect to an optical axis of said differential interference optical system and said at least one polarizing member itself is moved in a direction perpendicular to the optical axis of said differential interference optical system.

17. A differential interference optical system according to claim 2, wherein said at least one polarizing member is turned, with a center of rotation at a point lying on an optical axis of said differential interference optical system, other than a point where an interface between two wedges of said at least one polarizing member intersects with the optical axis of said differential interference optical system.

18. A differential interference optical system according to claim 14, wherein wedge members constituting each of said plurality of polarizing members have identical shapes and angles.

19. A differential interference optical system comprising:
a light source;
a first linearly polarizing element;
ray separating means for reflecting or transmitting a ray of light;
a birefringent member;
an observing optical system; and
a second linearly polarizing element,
said birefringent member being rotated 180° around a rotary axis which lies in a plane including an optical axis and a normal of an interface of said birefringent member.

20. A differential interference optical system according to claim 3 or 19, wherein said rotary axis is positioned to be parallel to a surface of said member and to lie on a center line of, or separate from, said member.

21. A differential interference optical system according to claim 3 or 19, wherein said rotary axis is positioned to satisfy the following condition:

|Δθ|×d<12
where d is a thickness of said member, in millimeters, and Δθ is an angle made by a normal of a surface of said member with said rotary axis, in degrees.

22. A differential interference optical system according to claim 3, wherein an angle made by a normal of a surface of said at least one polarizing member with an optical axis of said differential interference optical system can be changed.

23. A differential interference optical system according to any one of claims 3 or 19-22, wherein said first polarizing member or said second polarizing member is a Wollaston prism or a Nomarski prism.

24. A differential interference optical system according to claim 1, wherein each of said first polarizing member and said second polarizing member includes a combined body having two wedge-shaped prisms cemented to each other so that at least one polarizing member of said first polarizing member and said second polarizing member is previously rotated 180° around a rotary axis lying in a plane including an optical axis and a normal of an interface between said two wedge-shaped prisms, and thereby a distance from said at least one polarizing member to a position of localized fringes can be changed.
